(19) United States
(12) Patent Application Publication
(10) Pub. No.: US 2010/0194982 A1
(43) Pub. Date: Aug. 5, 2010

(54) MULTI-MEDIA PRESENTATION PLATFORM WITH INTERNALLY INTEGRATED DEVICES

(76) Inventors: Stuart C. Farmer, Orem, UT (US); Matthew J. Redd, Pleasant Grove, UT (US); Marcus Clawson, Orem, UT (US)

Correspondence Address: Workman Nydegger;1000 Eagle Gate Tower, 60 East South Temple, Salt Lake City, UT, 84111, US

(21) Appl. No.: 12/697,811

(22) Filed: Feb. 1, 2010

Related U.S. Application Data
(60) Provisional application No. 61/149,811, filed on Feb. 4, 2009.

(51) Int. Cl. H04N 7/00

(52) U.S. Cl. 348/552; 348/E05.001

(57) ABSTRACT

The present invention extends to a multi-media presentation platform with internally integrated devices. Embodiments of the present invention include an individual transportable multi-media presentation platform for presenting multi-media output. The multi-media platform integrates video output capabilities and audio mixing capabilities within a multi-media presentation platform console. Multi-media devices are secured to the console. Data, audio-visual, and power connections for and between multi-media devices attached to the console are pre-connected and secured within the console. The console can be configured to fit into a hard shell carrying case with custom foam fittings. Accordingly, the multi-media presentation platform is relatively robust and is easy to transport, setup, and operate. Embodiments include an all-in-one sound and video projection platform used for playing movies and media on an external projection screen which permanently houses built in audio-visual components.

### CROSS-REFERENCE TO RELATED APPLICATIONS

This application claims the benefit of U.S. Provisional Pat. Appl. No. 61/149,811, entitled “Multi-media Presentation Platform With Internally Integrated Devices”, filed on Feb. 4, 2009, which is incorporated by reference herein in its entirety.

### BACKGROUND

### Background and Relevant Art

Outdoor multi-media presentations typically require transportation, configuration (setup), and use of a number of different audio-visual components, such as, for example, a DVD player, audio mixer, and projector. The different audio-visual components are usually transported in separate cases. Upon arrival at the presentation site, the different audio-visual components are individually unpacked. After unpacking, the components are individually connected to a power source and various data connections are made between components using appropriate cables. For example, a video cable can be connected from the video output of a DVD player to the video input of a projector. After a multi-media presentation is complete, the different audio-visual components are individually disconnected from the power source and from one another. The different audio-visual components are then individually re-packed in their corresponding cases along with any cables for transportation.

Connecting and disconnecting different multi-media components from one another in the appropriate way requires some level of technical expertise. For example, attempting to configure a DVD player, audio mixer, and projector to present a movie requires a number of interconnections between ports on the different devices using appropriate types of cables. Unfortunately, appropriately making these interconnections is beyond the technical expertise of some individuals. Further, even when interconnections appear to be correct, technical problems preventing correct interoperation between audio-visual devices can still occur. For example, a projector or DVD player may be operating in an incorrect mode or the integrity of a cable may prevent a proper electrical connection between devices. Thus, even if an individual can correctly connected devices to one another, the individual may lack further technical expertise required to troubleshoot audio-visual devices and connections when additional technical problems occur.

Further, since audio-visual devices are continual connected and disconnected from one another, electrical and/or data ports on the audio-visual devices can degrade resulting in less than optimal operation. Thus, even if a user consistently connects audio-visual devices correctly, there may nonetheless come a time when the audio-visual devices do not interoperate as intended. However, the user may have no way to easily determine the cause of the problem. For example, a port may appear fine under visual inspection even when the electrical characteristics of the port are less than optimal.

Additionally, transporting a number of different cases, each containing a different audio-visual component can cause logistical difficulties. For example, a user may be required to make a separate trip on foot between a vehicle and the site of a multi-media presentation for each audio-visual component. In outdoor areas, access to a presentation site can require traversing less favorable terrain requiring that a vehicle be parked some distance from the presentation site. As such, a user may be required to make multi trips over the terrain to move all required audio-visual components to the presentation site.

### BRIEF SUMMARY

The present invention extends to a multi-media presentation platform with internally integrated devices. Embodiments of the invention include a multi-media presentation platform including a plurality of multi-media devices. The multi-media platform includes a console. The console has an input power inlet to power multi-media devices attached to the console and external audio/video ports for sending and receiving multi-media data. A power strip is attached to the console. The power strip includes an input power port to power the power strip and a plurality of output power ports to supply power to multi-media devices attached to the console.

A DVD player is also attached to the console. The DVD player is configured to output multi-media data including audio and video data. The DVD player includes a power input port for receiving power, a sending video port for sending the video data, and a sending audio port for sending the audio data. A projector is also attached to the console. The projector includes a power input port for receiving power and a receiving video port for receiving video data. An audio mixer is also attached to the console. The audio mixer includes a power input port for receiving power, a plurality of receiving audio ports for receiving audio data, and a plurality of sending audio ports for outputting mixed audio data.

The multi-media platform also includes a plurality secured wired connections secured to the console. The secured wired connections connect between devices attached to the console. The secured wired connections include a wired power connection from a first power output port of the power strip to the power input port of the DVD player to provide power to the DVD player. The secured wired connections also include a wired power connection from a second power output port of the power strip to the power input port of the projector to provide power to the projector. The secured wired connections also include a wired power connection from a third power output port of the power strip to the power input port of audio mixer to provide power to the audio mixer. The secured wired connections also include a wired video connection between the sending video port of the DVD player and the receiving video port of the projector such that the DVD player can output video data to the projector. The secured wired connections also include a wired audio connection between the sending audio port of the DVD player and a first receiving audio port of the audio mixer such that the DVD player can output audio data to the audio mixer.

In other embodiments, a computing device provides audio/video functionality. In these other embodiments, a console has an input power inlet to power multi-media devices attached to the console and external audio/video ports for sending and receiving multi-media data. The external audio/video ports include an audio output port for connection to external speakers or headphones. A power strip is attached to the console. The power strip includes an input power port to power the power strip and a plurality of output power ports to supply power to multi-media devices attached to the console.

A computing device attached to the console. The computing device includes a media player configured to output multi-media data including audio and video data. The computing device also includes a power input port for receiving power, a sending video port for sending the video data, a plurality of receiving audio ports for receiving audio data, and a sending audio port for sending mixed audio data. The computing device also includes audio mixing software for mixing audio data received at the receiving audio ports into a mixed audio signal for output at the sending audio port.

A projector is attached to the console. The projector includes a power input port for receiving power and a receiving video port for receiving video data.

The multi-media platform also includes a plurality secured wired connections secured to the console. The secured wired connections connect between devices attached to the console. The secured wired connections include a wired power connection from a first power output port of the power strip to the power input port of the computing device player to provide power to the computing device player. The secured wired connections also include a wired power connection from a second power output port of the power strip to the power input port of the projector to provide power to the projector. The secured wired connections also include a wired video connection between the sending video port of the computing device and the receiving video port of the projector such that the computing device can output video data to the projector. The secured wired connections also include a wired audio connection between the sending audio port of the computer system and the audio output port of console such that the computer system can output mixed audio data to external speakers or headphones.

In some embodiments, a custom audio-visual console permanently houses and mounts one or more audio-visual components (e.g., at least one video component and at least one audio component) in a fashion that allows the components to be readily used without reconfiguration.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A depicts an example multi-media presentation platform including a console with internally integrated components.

FIG. 1B depicted the console of FIG. 1A secured for transportation within a hardened case.

FIG. 2 depicts a schematic representation of example power (inter)connections and device (inter)connections internally integrated within a multi-media presentation platform console.

### DETAILED DESCRIPTION OF THE PREFERRED EMBODIMENTS

The present invention extends to a multi-media presentation platform with internally integrated devices. Embodiments of the invention include a multi-media presentation platform including a plurality of multi-media devices. The multi-media platform includes a console. The console has an input power inlet to power multi-media devices attached to the console and external audio/video ports for sending and receiving multi-media data. A power strip is attached to the console. The power strip includes an input power port to power the power strip and a plurality of output power ports to supply power to multi-media devices attached to the console.

A DVD player is also attached to the console. The DVD player is configured to output multi-media data including audio and video data. The DVD player includes a power input port for receiving power, a sending video port for sending the video data, and a sending audio port for sending the audio data. A projector is also attached to the console. The projector includes a power input port for receiving power and a receiving video port for receiving video data. An audio mixer is also attached to the console. The audio mixer includes a power input port for receiving power, a plurality of receiving audio ports for receiving audio data, and a plurality of sending audio ports for outputting mixed audio data.

The multi-media platform also includes a plurality secured wired connections secured to the console. The secured wired connections connect between devices attached to the console. The secured wired connections include a wired power connection from a first power output port of the power strip to the power input port of the DVD player to provide power to the DVD player. The secured wired connections also include a wired power connection from a second power output port of the power strip to the power input port of the projector to provide power to the projector. The secured wired connections also include a wired power connection from a third power output port of the power strip to the power input port of audio mixer to provide power to the audio mixer. The secured wired connections also include a wired video connection between the sending video port of the DVD player and the receiving video port of the projector such that the DVD player can output video data to the projector. The secured wired connections also include a wired audio connection between the sending audio port of the DVD player and a first receiving audio port of the audio mixer such that the DVD player can output audio data to the audio mixer.

In other embodiments, a computing device provides audio/video functionality. In these other embodiments, a console has an input power inlet to power multi-media devices attached to the console and external audio/video ports for sending and receiving multi-media data. The external audio/video ports include an audio output port for connection to external speakers or headphones. A power strip is attached to the console. The power strip includes an input power port to power the power strip and a plurality of output power ports to supply power to multi-media devices attached to the console.

A computing device attached to the console. The computing device includes a media player configured to output multi-media data including audio and video data. The computing device also includes a power input port for receiving power, a sending video port for sending the video data, a plurality of receiving audio ports for receiving audio data, and a sending audio port for sending mixed audio data. The computing device also includes audio mixing software for mixing audio data received at the receiving audio ports into a mixed audio signal for output at the sending audio port.

A projector is attached to the console. The projector includes a power input port for receiving power and a receiving video port for receiving video data.

The multi-media platform also includes a plurality secured wired connections secured to the console. The secured wired connections connect between devices attached to the console. The secured wired connections include a wired power connection from a first power output port of the power strip to the power input port of the computing device player to provide power to the computing device player. The secured wired connections also include a wired power connection from a second power output port of the power strip to the power input port of the projector to provide power to the projector. The secured wired connections also include a wired video connection between the sending video port of the computing device and the receiving video port of the projector such that the computing device can output video data to the projector. The secured wired connections also include a wired audio connection between the sending audio port of the computer system and the audio output port of console such that the computer system can output mixed audio data to external speakers or headphones.

In some embodiments, a custom audio-visual console permanently houses and mounts one or more audio-visual components (e.g., at least one video component and at least one audio component) in a fashion that allows the components to be readily used without reconfiguration.

Accordingly, embodiments of the invention integrate a plurality of multimedia devices within a reduced size form factor that is portable by a single individual. For example, a projector, a Digital Video Disc (DVD) player, and a mixer, a power supply, and appropriate power to device and device to device interconnections (e.g., wires) can be secured to and/or secured within an appropriately configured stand. The stand can be protectively contained with a transportable roller case. Thus, within the transportable roller case, are contained virtually all needed devices for presenting multi-media output (e.g., a movie). Accordingly, a single individual can easily transport the stand, within the transportable roller case, to a multi-media presentation venue.

Embodiments of the invention include an all-in-one sound and video projection console used for playing movies and media on an external projection screen. For example, an appropriately configured console can permanently house a built in video (e.g., a Digital Light Processing (DLP) projector, a portable (e.g., HD-DVD or Blu-ray) DVD player with a Liquid Crystal Display (LCD) screen, an (e.g., multi-channel) audio mixer, a wired or wireless microphone, a light (for illumination of the console), external power connections, and external audio connection points (for connecting speakers, headphones, microphones, and external audio sources). The console can also include built-in internal electrical wiring allowing each multi-media device to be permanently installed and plugged-in. Power to the internal electrical wiring is received from a single external power port. Devices at the console are also pre-connected to one another with their appropriate audio and video wires. Any wiring is pre-connected and secured to the console to reduce the chance of operating errors due to wires being disconnecting.

Accordingly, a user can easily operate the console without requiring knowledge of how to connect the devices to one another. However, in some embodiments, the console (as well as one or more of the interconnected devices) can also include external connections to receive inputs from and/or provide outputs (e.g., audio, video, digital, power, etc.) to other devices, such as, for example, personal digital assistants (PDAs), mobile telephones, speakers, headphones, portable MP3 players, computers, gaming consoles, cameras, video cameras, etc. The entire console can fit into a hard shell carrying case with custom foam fittings.

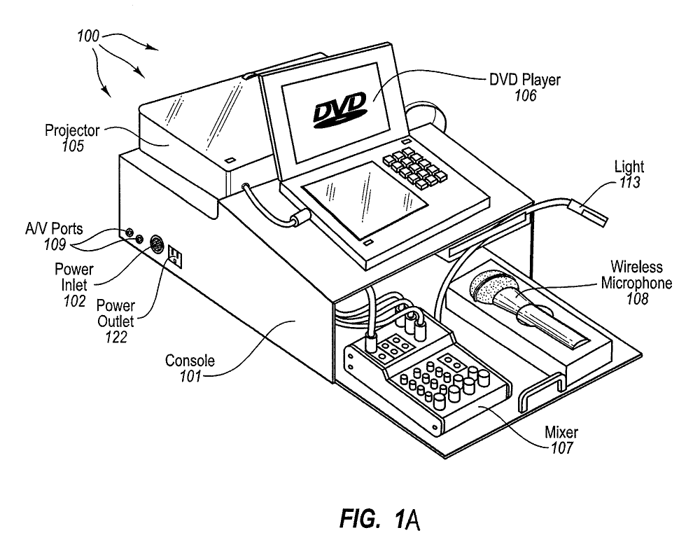

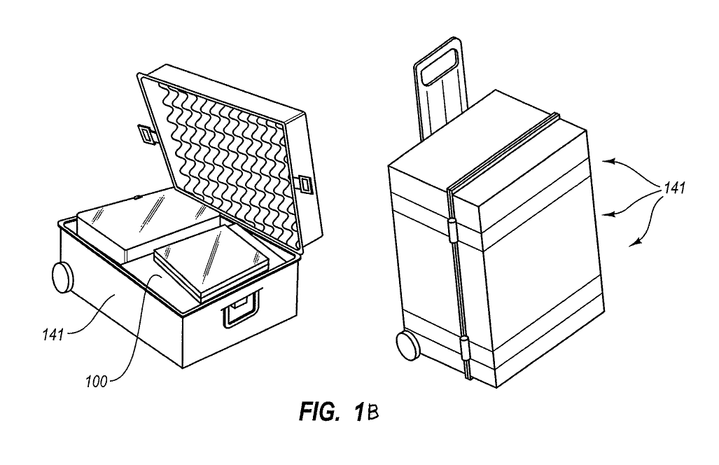

FIG. 1A depicts an example multi-media presentation platform 100 in accordance with the principals of the present invention. As depicted, multi-media presentation platform 100 includes console 101. Attached to console 101 are DVD player 106, Mixer 107, Projector 105, wireless microphone 108, and light 113. Console 101 includes A/V ports 109, power inlet 102, and power outlet 122. The attached devices and depicted ports are appropriately connected to one another via wiring contained within and/or on the external surfaces of console 101.

FIG. 1B depicts that console 101 can be secured within and transported within pelican case 141.

Accordingly, embodiments of multi-media presentation platforms in accordance with the principles of the present invention integrate different individual devices having video inputs and/or outputs (e.g., projector 105 and DVD player 106) with devices having audio inputs and/or outputs (e.g., DVD player 106, mixer 107 and wireless microphone 108) together on single individually (e.g., all-in-one) transportable console. Further, embodiments provide external audio/video connections to facilitate additional expanded functionality through connections to other external devices (e.g., digital assistants (PDAs), mobile telephones, speakers, headphones, portable MP3 players, computers, gaming consoles, cameras, video cameras).

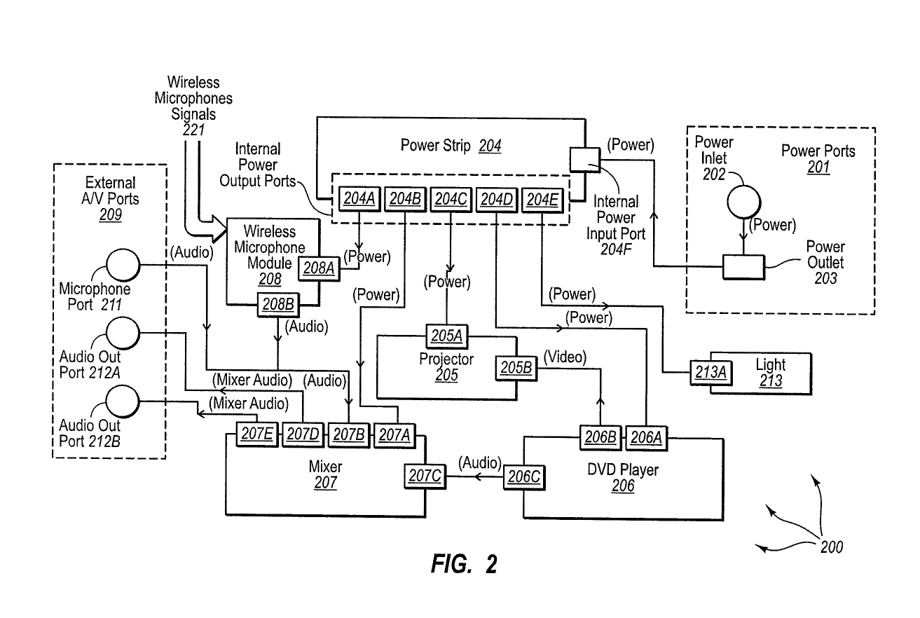

Integrated power (inter)connections and device (inter)connections within console 101 can be configured in any number of different ways. FIG. 2 depicts a schematic representation 200 of example power (inter)connections and device (inter)connections internally integrated within a multi-media presentation platform console. Within schematic representation 200, arrows indicate the direction of travel of signals, such as, for example, power, audio, video, etc. For example, power flows from power strip 204 out of port 204D to DVD player 206 into port 206A. Likewise, an audio signal travels from DVD player 206 out of port 206C to mixer 207 into port 207C.

As depicted, schematic representation 200 includes external power ports 201. External power ports 201 include power inlet 202 (e.g., 102) and power outlet 203 (e.g., 122). Power inlet 202 is configured to receive a power cord connected to a power source (e.g. in any standard residential, commercial, or industrial voltage) for supplying power to the multi-media presentation platform. Power inlet 202 is connected to power outlet 203. Power flows from power inlet 202 to power outlet 203. Accordingly, external devices can be powered from (e.g., plugged into) power outlet 203. Power also flows from power outlet 203 to power strip 204 into internal power input port 204F (whether or not power outlet 203 is utilized). Power strip 204 includes internal power output ports 204, such as, for example, 204A, 204B, 204C, 204D, and 204E, for powering the integrated devices of a multi-media presentation platform.

As further depicted, schematic representation 200 includes light 213 (e.g., light 113), DVD player 206 (e.g., DVD player 106), projector 205 (e.g. projector 105), mixer 207 (mixer 107), and wireless microphone module 208. A power connection facilitates power flowing out of port 204E of power strip 204 into port 213A of DVD player 213. Light 213A provides illumination at a multi-media presentation platform to assist a user in operation of the multi-media devices of a multi-media presentation platform in lower light environments.

A power connection facilitates power flowing out of port 204D of power strip 204 into port 206A of DVD player 206. DVD player 206 can compatible play a variety of types of discs having data of a variety of a different formats included thereon. For example, DVD player 206 can be configured to compatibly receive one or more different types of discs, such as, for example, DVDs, Compact Discs (CDs), mini discs, laser discs, etc. Thus, DVD player 206 can be configured to read and output audio/audio data from one or more of standard DVD (e.g., DVD-ROM, DVD-R. DVD+R DVD-RAM, DVD-RW, DVD+RW, etc.), HD-DVD, and Bluray formatted discs. DVD player 206 can also be configured to compatibly read and output audio data from one or more Compact Disc (CD) data formats, such as, for example, CD-R), CD-RW), SACD, VCD, SVCD, PhotoCD, PictureCD, CD-i, etc. DVD player 206 can also thus be configured to read and output audio/video data in a variety of different formats, such as, for example, MP3, any other MPEG formats and ancillary standards (e.g., MPEG-1, 2, 3, 4 (parts 2 and 10), 7, 21, A, B, C, D, E, etc.) WAV, etc. from any type of disc that can be compatibly received.

As depicted, a video connection facilitates a video signal (digital or analog) flowing out of port 206B of DVD player 206 into port 205B of projector 205. A power connection facilitates power flowing out of port 204C of power strip 204 into port 205A of projector 205. Accordingly, projector 205 can receive a video signal from DVD player 206 and output (project) video for viewing.

As depicted, an audio connection facilitates audio signal (analog or digital) flowing out of port 206C of DVD player 206 into port 207C of mixer 207. A power connection facilitates power flowing out of port 204B of power strip 204 into port 207A of mixer 207. Accordingly, mixer 207 can receive an audio signal from DVD player 206.

A power connection facilitates power flowing out of port 204A of power strip 204 into port 208B of wireless microphone module 208. Wireless microphone module 208 is configured to receive wireless microphone signals, such as, for example, wireless microphone signals 221, from a wireless microphone (e.g., wireless microphone 108) and convert the wireless microphone signals into an audio signal (analog or digital). As depicted, an audio connection facilitates an audio signal flowing out of port 208B of wireless microphone module 208 into port 207B of mixer 207.

Also depicted in schematic representation 200 are external A/V ports 209. External A/V ports 209 include microphone port 211, audio output port 212A, and audio output port 212B. An external wired microphone can be connected to microphone port 211. Components in the external microphone can provide an audio signal (analog or digital) that flows from the external microphone into microphone port 211. From microphone port 211, the audio signal can flow into port 207B or mixer 207.

Mixer 207 is configured to mix, route, and change the level, timbre and/or dynamics of audio signals. Mixer 207 can mix analog and/or digital signals to create a combined audio output signal. For example, modified audio signals (voltages or digital samples) can be summed to produce the combined audio output signals.

Accordingly, mixer 207 can receive a plurality of audio signals from different multi-media devices (e.g., DVD player 206 and a wireless microphone) of and/or connected to a multi-media presentation platform. Mixer 207 can mix the received audio signals into a combined audio output signal for output. External speakers (or headphones) can be connected to audio out ports 212A and 212B. As depicted, an audio connection facilitates a mixed audio signal (analog or digital) flowing out of ports 207D and 207E of mixer 207 player 206 into audio output ports 221A and 221B respectively. From audio output ports 221A and 221B the mixed audio signal can flow into connected external speakers. Accordingly, external speakers can receive a mixed audio signal from mixer 207 and output sound for listening.

A multi-media presentation platform can also integrate other types of multi-media devices and/or include other types of external A/V ports. A multi-media presentation platform can essentially include any type of multi-media device that can be externally connected to the multi-media presentation platform. For example, a multi-media presentation platform can include a laptop computer system, a PDA, an MP3 player, etc. Connections for these multi-media devices can be integrated into the multi-media presentation platform to function with the multi-media devices expressly depicted in FIG. 2. For example, audio output from an MP3 player can be connected to mixer 207. Thus, an audio signal can flow from the MP3 player to the mixer. The audio signal can be mixed with other receive audio signals into a mixed audio signal for output at external speakers (or headphones).

Other types of video devices can also be including in a multi-media presentation platform. Thus, integrated video connections can also be included. A video switch to switch between video signals from different video devices to control what projector 205 (or a laptop, PDA, or DVD player screen) outputs.

Other types of external ports can include VGA, DVI, S-Video, USB, Firewire, Ethernet, etc. A multi-media presentation platform can also include other wireless modules (e.g., a wireless network module) for exchanging A/V data with and/or providing commands to or receiving commands from external multi-media devices.

In some embodiments, a laptop computer is used instead of mixer 207 and DVD player 206. The laptop computer includes a disc player to provide the functionality of DVD player 206 and mixing software to provide the functionality of mixer 207. Alternately, multi-media content can be played off of an internal drive of the computer laptop computer, such as, for example, a magnetic or optical disk.

As previously described, an attached devices and ports are appropriately connected to one another via wiring contained within and/or on the external surfaces of a console, such as, for example, console 101.

Accordingly, embodiments of the present invention include an individual transportable multi-media presentation platform for presenting multi-media output. The multi-media platform integrates video output capabilities and audio mixing capabilities in a multi-media presentation platform. Since connections for multi-media devices of the multi-media presentation platform are pre-connected and secured, the multi-media presentation platform relatively robust and easy to setup and operate.

Other embodiments include an all-in-one sound and video projection platform used for playing movies and media on an external projection screen. The all-in-one sound and video projection platform is comprised of a custom made console which permanently houses a built in video projector, a portable DVD player with LCD (liquid crystal display) screen, an audio mixer, a wired or wireless microphone, an internal light (for illumination of the console), external power connections, and external audio connection points (for connecting speakers, headphones, microphones, and external audio sources). The custom made console has built-in internal electrical wiring allowing each electrical component to be permanently installed and plugged in with the need for only one external power plug. The components are also pre-connected with their appropriate audio and video cords allowing for the user to operate the console without the need to connect each of the components with every use. The entire console fits into a hard shell carrying case with custom foam fittings

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical storage media and transmission media.

Physical storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

With this description and following claims, a “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, it should be understood, that upon reaching various computer system components, program code means in the form of computer-executable instructions or data structures can be transferred automatically from transmission media to physical storage media (or vice versa). For example, computer-executable instructions or data structures received over a network or data link can be buffered in RAM within a network interface module (e.g., a “NIC”), and then eventually transferred to computer system RAM and/or to less volatile physical storage media at a computer system. Thus, it should be understood that physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A multi-media presentation platform including a plurality of multi-media devices, the multi-media presentation platform comprising:
a console, the console having an input power inlet to power multi-media devices attached to the console and external audio/video ports for sending and receiving multi-media data;
a power strip attached to the console, the power strip including an input power port to power the power strip and a plurality of output power ports to supply power to multi-media devices attached to the console;
a DVD player attached to the console, the DVD player configured to output multi-media data including audio and video data, the DVD player including a power input port for receiving power, a sending video port for sending the video data, and a sending audio port for sending the audio data;
a projector attached to the console, the projector including a power input port for receiving power and a receiving video port for receiving video data;
an audio mixer attached to the console, the audio mixer including a power input port for receiving power, a plurality of receiving audio ports for receiving audio data, and a plurality of sending audio ports for outputting mixed audio data; and
a plurality secured wired connections between devices attached to the console, the secured wired connections secured to the console, the secured wired connections including:
a wired power connection from a first power output port of the power strip to the power input port of the DVD player to provide power to the DVD player;
a wired power connection from a second power output port of the power strip to the power input port of the projector to provide power to the projector;
a wired power connection from a third power output port of the power strip to the power input port of audio mixer to provide power to the audio mixer;
a wired video connection between the sending video port of the DVD player and the receiving video port of the projector such that the DVD player can output video data to the projector; and
a wired audio connection between the sending audio port of the DVD player and a first receiving audio port of the audio mixer such that the DVD player can output audio data to the audio mixer.

2. The multi-media presentation platform as recited in claim 1, wherein the console having external audio/video ports for sending and receiving multi-media data comprises the console having a microphone port for receiving audio data from a microphone and a plurality of audio out ports for providing audio signals to external speakers or headphones external to the console.

3. The multi-media-presentation platform as recited in claim 2, wherein the plurality secured wired connections between devices attached to the console further includes:
a wired audio connection between the microphone port and a first receiving audio port of the audio mixer such that a microphone can output audio data to the audio mixer; and
wired audio connections between the audio mixer and the audio output ports of the console such that the audio mixer can provide a mixed audio signal to external speakers or headphones connected to the console, including:
a wired audio connection from a first sending audio port of the audio mixer to a first audio out port of the console; and
a wired audio connection from a second sending audio port of the audio mixer to a second audio out port of the console.

4. The multi-media-presentation platform as recited in claim 1, wherein the console further includes:
one or more different types of external ports selected from among: VGA, DVI, S-Video, USB, Firewire, and Ethernet ports; and
wherein the secured wired connections secured to the console include appropriate wired connections between the one or more different types of ports and the multi-media devices attached to the console

5. The multi-media presentation platform as recited in claim 1, wherein the console further includes:
wireless modules (e.g., a wireless network module) for exchanging A/V data with and/or providing commands to or receiving commands from external multi-media devices.

6. The multi-media presentation platform as recited in claim 1, further comprising:
a light secured to the console, the light providing illumination to assist in operation of other multi-media devices attached to the console, the light including a power input port for receiving power; and
wherein the plurality secured wired connections between devices attached to the console, further including:
a wired power connection from a fourth power output port of the power strip to the power input port of the light to provide power to the light.

7. The multi-media presentation platform as recited in claim 1, further comprising:
a wireless microphone module for receiving wireless signals from a wireless microphone, the wireless microphone module including a power input port for receiving power and a sending audio port for sending the audio data;
wherein the plurality secured wired connections between devices attached to the console, further including:
a wired power connection from a fifth power output port of the power strip to the power input port of the wireless microphone module to provide power to the wireless microphone module; and
a wired audio connection between the sending audio port of the wireless microphone module and a first receiving audio port of the audio mixer such that the wireless microphone module can output audio data to the audio mixer.

8. A multi-media presentation platform including a plurality of multi-media devices, the multi-media presentation platform comprising:
a console, the console having an input power inlet to power multi-media devices attached to the console and external audio/video ports for sending and receiving multi-media data, the external audio/video ports including an audio output port for connection to external speakers or headphones;
a power strip attached to the console, the power strip including an input power port to power the power strip and a plurality of output power ports to supply power to multi-media devices attached to the console;
a computing device attached to the console, the computing device including a media player configured to output multi-media data including audio and video data, the computing device including a power input port for receiving power, a sending video port for sending the video data, a plurality of receiving audio ports for receiving audio data, and a sending audio port for sending mixed audio data, the computing device including audio mixing software for mixing audio data received at the receiving audio ports into a mixed audio signal for output at the sending audio port;
a projector attached to the console, the projector including a power input port for receiving power and a receiving video port for receiving video data; and
a plurality secured wired connections between devices attached to the console, the secured wired connections secured to the console, the secured wired connections including:
a wired power connection from a first power output port of the power strip to the power input port of the computing device player to provide power to the computing device player;
a wired power connection from a second power output port of the power strip to the power input port of the projector to provide power to the projector;
a wired video connection between the sending video port of the computing device and the receiving video port of the projector such that the computing device can output video data to the projector; and
a wired audio connection between the sending audio port of the computer system and the audio output port of console such that the computer system can output mixed audio data to external speakers or headphones.

9. An audio-visual console custom made to permanently house and mount audio-visual components in a fashion that allows the components to be readily used without reconfiguration, the audio-visual components including at least video component and at least one audio component.

10. The audio-visual console as recited in claim 9, wherein the audio-visual components are permanently installed or fixed to the console by means of screws, rivets and Velcro.

11. The audio-visual console as recited in claim 10, wherein the audio visual components are interconnected with their appropriate audio and video cabling allowing the user to operate the equipment without the need to connect the components to one another with each use.

12. The audio-visual console as recited in claim 11, wherein the audio-visual console has built in electrical wiring and power connections allowing each of the individual audio-visual components to be electrically permanently connected internally in the console.

13. The audio-visual console as recited in claim 12, wherein the audio-visual console has an external power plug, which is connected to the internal wiring and then to the individual power supplies of the individual audio-visual component, the external power plug being a single external power plug to provide electrical power for the entire console and each individual audio-visual component.

14. The audio-visual console as recited in claim 13, wherein the audio-visual console has external audio connections allowing for the connection of external speakers, audio players, microphones, and headphones, the external connections permanently connected internally to a built-in audio mixer which provides audio mixing and control capabilities between an internal projector, DVD player, and microphone to the external speakers.

15. The audio-visual console as recited in claim 14, wherein the audio-visual console fits into hard shell portable case with custom fitted foam for protection.
